(19) United States
(12) Patent Application Publication
(10) Pub. No.: US 2007/0233548 A1
(43) Pub. Date: Oct. 4, 2007

(54) Visitor support system, visitor support method, and recording medium

(76) Inventor: Takeshi Okawa, Saitama (JP)

Correspondence Address: MORRISON & FOERSTER LLP, 1650 TYSONS BOULEVARD, SUITE 400, MCLEAN, VA, 22102, US

(21) Appl. No.: 11/724,329

(22) Filed: Mar. 15, 2007

(30) Foreign Application Priority Data
Mar. 17, 2006 (JP) 2006-075690
Mar. 20, 2006 (JP) 2006-077039
Mar. 20, 2006 (JP) 2006-077043

(51) Int. Cl. G06F 15/02; G08B 23/00

(52) U.S. Cl. 705/9; 340/573.1

(57) ABSTRACT

Visitor support database stores information on visitors and staff members in charge of visitors. Visitor support server receives information on visitor from reception device and specifies staff member in charge of him/her. Server extracts information describing the visitor from the information on the visitor, generates correspondence message, and sends it to a staff member terminal.

Booth terminal specifies visitors in a booth based on reception information and information on visitors stored in database, and determines whether the visitors have an inclination. When the visitors have an inclination, booth terminal performs a demo to be performed at the booth according to this inclination.

Database stores information on handouts distributed at booths, and booth entry information. On receiving departure information from reception device, server specifies unvisited booths of a visitor based on the booth entry information, extracts information on handouts distributed at specified booths from database, and sends them to reception device.

### BACKGROUND OF THE INVENTION

1. Field of the Invention

The present invention relates to a visitor support system, a visitor support method, and a program, and particularly relates to a visitor support system, a visitor support method, and a recording medium for supporting visitors who come to an event site, and tasks relating to the reception of the visitors.

2. Description of the Related Art

Generally, at an event site or a showroom, etc. where an event is to be held, a reception work (reception procedure) for letting the visitors to the event site, etc. show information such as the name, the company name, the job title, etc. of the visitors, is carried out.

In such a reception procedure, for example, the information on the name, etc. of the visitors is managed by manual typing, by using a name card managing software application, etc. Therefore, the reception procedure often takes long and it is not rare that the visitors wait in a long line. Hence, a system that can easily process the reception procedure is demanded, and various proposals have been made to facilitate the reception procedure.

Further, many booths stand in the event site or showroom, etc. where an event is held, and a lot of people visit the site. Therefore, the visitors can hardly see around all the booths. Hence, a method and a system for allowing more visitors to see more booths are demanded, and various proposals relating to events have been made.

For example, Unexamined Japanese Patent Application KOKAI Publication No. 2003-122872 proposes a visitor reception system with which visitors to an event site, a showroom, etc. can easily check at the reception, by entering their personal information using their name card, etc.

In some events, for example, salespersons may wish to guide their clients, who come to the event site, around the site. In such a case, the clients need to do such a process as summoning up the salesperson by phone, etc., in the reception procedure.

At each booth, in order that the functions, etc. of the displayed product may be easily understood by the visitors, or in order to get the visitors intrigued by the displayed product, demonstrations (demos) such as running videos about the product are performed. However, such demos are often for merely running videos that are prepared beforehand, and it cannot be said that such demos are understandable for many visitors from various jobs, various ages, etc. In such a case, a system which can support the visitors by performing demos that match the visitors is demanded, so that the visitors can be interested.

Further, it actually happens that salespersons guide their clients coming to the event site around the site, so that the visitors can efficiently check many booths. However, in this case too, it is hard for the visitors to see all the booths they want to go to because of their time conditions, etc., and the visitors may wish to be informed about the products, etc. of the booths they have missed. Hence, a system which can support the visitors by providing information about products, etc. which the visitors have not checked is demanded.

### SUMMARY OF THE INVENTION

The present invention was made in view of the above-described problems, and an object of the present invention is to provide a visitor support system, a visitor support method, and a program which can support visitors, and tasks relating to the reception of the visitors.

To achieve the above object, a visitor support system according to a first aspect of the present invention comprises:

a prospective visitor information storage unit which stores information for specifying a prospective visitor who has a possibility of coming to a site and staff member specifying information for specifying a staff member who is to be in charge of the prospective visitor in association with each other;

a visitor information receiving unit which receives information for specifying a visitor who is checked at a reception, from a terminal device at the reception at which visitors are checked;

a staff member acquiring unit which acquires the staff member specifying information that specifies a staff member to be in charge of the visitor checked at the reception, based on the information for specifying the visitor received by the visitor information receiving unit, and the information stored in the prospective visitor information storage unit;

a correspondence message generating unit which generates a correspondence message for notifying that the visitor who is specified by the information for specifying the visitor received by the visitor information receiving unit has arrived at the site; and

a correspondence message sending unit which sends the correspondence message generated by the correspondence message generating unit to an address previously assigned to the staff member specified by the staff member specifying information acquired by the staff member acquiring unit.

The visitor support system may further comprise a visitor status receiving unit which receives status information indicating a visit status of the checked visitor, from the terminal device at the reception, and

the correspondence message generating unit may generate a correspondence message for notifying the status indicated by the status information received by the visitor status receiving unit.

The status information may be information indicating a number of accompanying persons who accompany the checked visitor.

The prospective visitor information storage unit may further store information for specifying a product which a prospective visitor, who is stored, is interested in, in association with the information for specifying the prospective visitor, and

the visitor support system may further comprise:

a product explanatory material storage unit which stores the information for specifying the product and data of an explanatory material for explaining the product in association with each other;

a product-of-interest specifying unit which specifies a product which the checked visitor is interested in, based on the information stored in the prospective visitor information storage unit;

a product explanatory material acquiring unit which acquires data of an explanatory material for explaining the product specified by the product-of-interest specifying unit, from the product explanatory material storage unit;

an explanatory material sending unit which sends the data acquired by the product explanatory material acquiring unit to the terminal device at the reception; and

an explanatory material printing unit which prints the explanatory material by using the data sent from the explanatory material sending unit.

In a case where no response to the correspondence message is returned from the staff member who is an addressee of the correspondence message within a predetermined period of time after the correspondence message is sent, the correspondence message sending unit may send the correspondence message to a staff member to serve in place, who is pre-associated with the staff member.

In the visitor support system, which is for supporting a visitor, who has come to a predetermined site having a plurality of booths, in seeing around the site,

the prospective visitor information storage unit may further store attribute information indicating an attribute of a prospective visitor, who is stored, in association with the stored information for specifying the prospective visitor, and

the visitor support system may further comprise:

a booth entry/leave information storage unit which stores information for specifying a visitor who enters any predetermined one of the booths, and entry/leave information indicating dates and times of entry and leave the visitor enters and leaves the booth, in association with each other;

a booth visitor specifying unit which specifies visitors who are in the predetermined booth, based on the information stored in the booth entry/leave information storage unit;

an attribute information specifying unit which specifies the attribute information of the visitors who are in the predetermined booth, specified by the booth visitor specifying unit, based on the information stored in the prospective visitor information storage unit;

a demo specifying unit which specifies a demo to be performed in the booth, based on the attributed information specified by the attribute information specifying unit; and

a demo performing unit which performs the demo specified by the demo specifying unit.

The demo specifying unit may comprise an inclination determining unit which determines whether the attributes indicated by the attribute information specified by the attribute information specifying unit have a predetermined inclination, and

in a case where the inclination determining unit determines that the attributes have a predetermined inclination, the demo specifying unit may specify a demo according to the predetermined inclination.

The demo specifying unit may specify at least one of a product to be demonstrated, a content of the demo, and a place at which the demo is performed.

The visitor support system may further comprise a demo information storage unit which stores data of a demo to be performed in any predetermined booth, and inclination information indicating an inclination of attributes of visitors, for which the demo can be effective, in association with each other, and

in a case where inclination determining unit determines that the attributes have a predetermined inclination, the demo specifying unit may specify data of a demo which matches the predetermined inclination, from the information stored in the demo information storage unit.

The attribute information may include at least one of information pieces indicating a business category, age, sex, and residence area of a visitor, and

the inclination determining unit may determine that visitors have a predetermined inclination, when there is a certain bias in business categories, ages, sexes, or residence areas of the visitors, which are indicated by the attribute information specified by the attribute information specifying unit.

The visitor support system, which is for supporting a visitor, who has come to a predetermined site having a plurality of booths, in seeing around the site, may further comprise:

a booth visitor information receiving unit which receives information for specifying a visitor who is checked by a terminal device which checks visitors who are to enter any of the booths, and a booth specifying information for specifying a booth entered by the visitor, from the terminal device;

a booth visitor storage unit which stores the information for specifying the visitor and the booth specifying information, which are received by the booth visitor information receiving unit, in association with each other;

a departing person information receiving unit which receives information for specifying a departing person, who is checked by the terminal device at the reception at which departing persons who are to leave the predetermined site are checked, from the terminal device;

an unvisited booth specifying unit which specifies a booth which has not been visited by the departing person, from the information for specifying the departing person received by the departing person information receiving unit and the information stored in the booth visitor storage unit; and

a display unit which displays the booth specified by the unvisited booth specifying unit as not having been visited.

The visitor support system may comprise:

a handout storage unit which stores the booth specifying information for specifying a booth, and data of a handout distributed at the booth, in association with each other;

a handout extracting unit which extracts data of a handout distributed at the booth specified by the unvisited booth specifying unit, from data of handouts stored in the handout storage unit;

a handout sending unit which sends the data of the handout extracted by the handout extracting unit to the terminal device at the reception; and

a handout printing unit which prints the handout by using the data of the handout sent from the handout sending unit.

The prospective visitor information storage unit may further store information for specifying a product which a prospective visitor, who is stored, is interested in, in association with the stored information for specifying the prospective visitor,

the handout storage unit may further store product specifying information for specifying a product, which is featured at a booth specified by the stored booth specifying information, in association with the booth specifying information, and

the handout extracting unit may: comprise a product-of-interest featuring booth specifying unit which specifies a booth which features a product which the departing person is interested in, among booths specified by the unvisited booth specifying unit as not having been visited by the departing person, based on the information stored in the prospective visitor information storage unit and the handout storage unit; and may extract data of a handout distributed at the booth specified by the product-of-interest featuring booth specifying unit from the data of handouts stored in the handout storage unit.

To achieve the above object, a visitor support method according to a second aspect of the present invention comprises:

a prospective visitor information storing step of storing information for specifying a prospective visitor who has a possibility of coming to a site and staff member specifying information for specifying a staff member who is to be in charge of the prospective visitor in association with each other;

a visitor information receiving step of receiving information for specifying a visitor who is checked at a reception, from a terminal device at the reception at which visitors are checked;

a staff member acquiring step of acquiring the staff member specifying information that specifies a staff member to be in charge of the checked visitor, from the information for specifying the visitor received at the visitor information receiving step and the information stored at the prospective visitor information storing step;

a correspondence message generating step of generating a correspondence message for notifying that the visitor specified by the information for specifying the visitor received at the visitor information receiving step has arrived at the site; and

a correspondence message sending step of sending the correspondence message generated at the correspondence message generating step to an address previously assigned to the staff member specified by the staff member specifying information acquired at the staff member acquiring step.

To achieve the above object, a recording medium according to a third aspect of the present invention stores a program for controlling a computer to function as:

a prospective visitor information storage unit which stores information for specifying a prospective visitor who has a possibility of coming to a site and staff member specifying information for specifying a staff member who is to be in charge of the prospective visitor in association with each other;

a visitor information receiving unit which receives information for specifying a visitor who is checked at a reception, from a terminal device at the reception at which visitors are checked;

a staff member acquiring unit which acquires the staff member specifying information that specifies a staff member to be in charge of the visitor checked at the reception, based on the information for specifying the visitor received by the visitor information receiving unit, and the information stored in the prospective visitor information storage unit;

a correspondence message generating unit which generates a correspondence message for notifying that the visitor who is specified by the information for specifying the visitor received by the visitor information receiving unit has arrived at the site; and

a correspondence message sending unit which sends the correspondence message generated by the correspondence message generating unit to an address previously assigned to the staff member specified by the staff member specifying information acquired by the staff member acquiring unit.

### BRIEF DESCRIPTION OF THE DRAWINGS

These objects and other objects and advantages of the present invention will become more apparent upon reading of the following detailed description and the accompanying drawings in which:

FIG. 1 is a diagram showing the structure of a visitor support system according to an embodiment of the present invention;

FIG. 2 is a diagram showing the structure of a visitor support server of FIG. 1;

FIG. 3 is a diagram showing the structure of a visitor support database of FIG. 1;

FIG. 4 is a diagram showing the structure of a reception information database;

FIG. 5 is a diagram showing the structure of a client information database;

FIG. 6 is a diagram showing the structure of a staff member information database;

FIG. 7 is a diagram showing the structure of an explanatory material information database;

FIG. 8 is a diagram showing the structure of a handout information database;

FIG. 9 is a diagram showing the structure of a reception device;

FIG. 10 is a diagram showing an example of an admission ticket;

FIG. 11 is a diagram showing the structure of a booth terminal;

FIG. 12 is a diagram showing the structure of a booth reception information database;

FIG. 13 is a diagram showing the structure of a booth client information database;

FIG. 14 is a diagram showing the structure of a schedule information database;

FIG. 15 is a diagram showing the structure of a demo information database;

FIG. 16 is a diagram showing an example of a staff member menu page;

FIG. 17 is a flowchart for explaining a registration task;

FIG. 18 is a flowchart for explaining an admission task;

FIG. 19 is a diagram showing an example of a screen on which information on a visitor is displayed;

FIG. 20 is a flowchart for explaining a booth entry task by a booth terminal;

FIG. 21 is a flowchart for explaining a booth entry/leave task by the visitor support server;

FIG. 22 is a flowchart for explaining a demo task;

FIG. 23 is a flowchart for explaining a departure task; and

FIG. 24 is a diagram showing the structure of a visitor support system according to another embodiment.

### DETAILED DESCRIPTION OF THE PREFERRED EMBODIMENT

A visitor support system, a visitor support method, and a program according to a embodiment of the present invention will be explained below. In the present embodiment, as will be described later, an RFID (Radio Frequency Identification) admission ticket, i.e., an admission ticket in which an IC chip on which information on a visitor is written is embedded, is distributed to the visitor (client) beforehand, and the visitor comes to the event site with this RFID admission ticket. By the RFID admission ticket being read by an RFID handy reader at the entrance/exit (reception) of the event site and at the entrance/exit of each booth, the information on the visitor is registered to the system. Further, in order that a staff member, who is in charge of sales, etc. may guide his/her client coming to the event site around, a notification is given to the staff member in charge that a client has arrived at the event site. Further, in the present embodiment, the invention will be explained in an example where the demonstration (demo) at the booth is by running a video about product description.

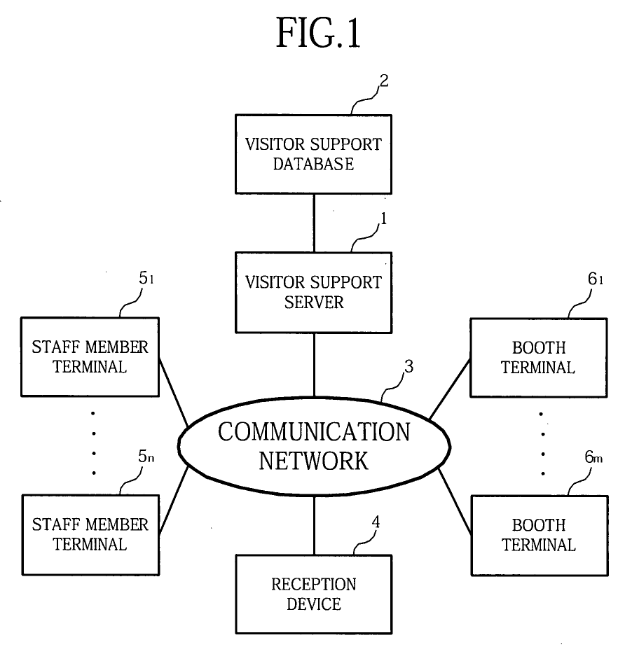

As shown in FIG. 1, the visitor support system comprises a visitor support server 1, a visitor support database 2, a communication network 3, a reception device 4 connected through the communication network 3, staff member terminals 5 (5₁ to 5ₙ) connected through the communication network 3, and booth terminals 6 (6₁ to 6ₘ) connected through the communication network 3.

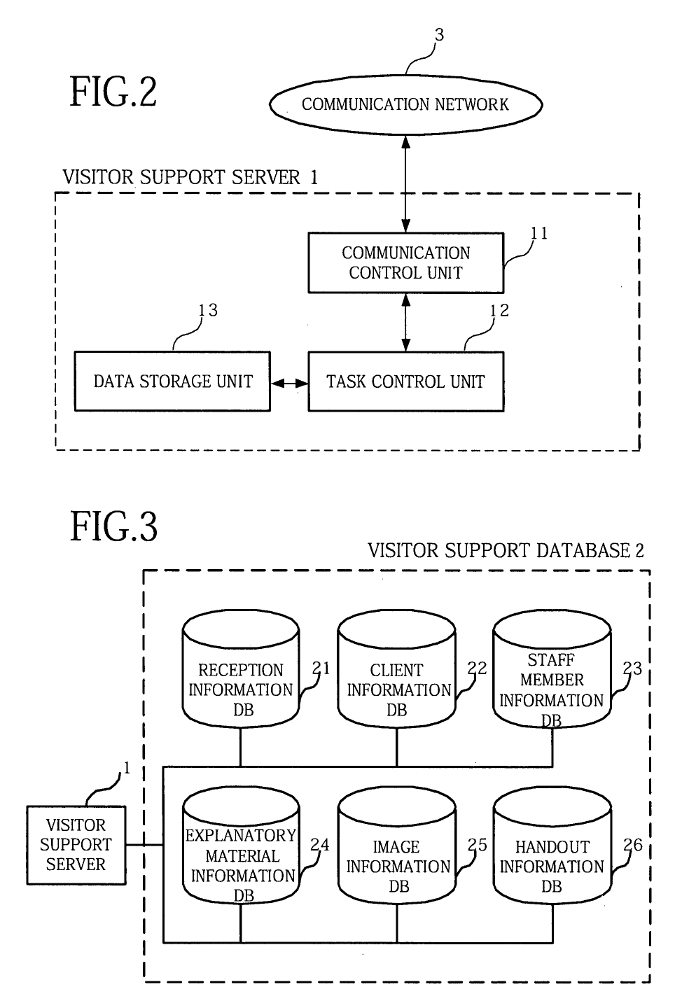

The visitor support server 1 processes various tasks relating to the visitor support system. As shown in FIG. 2, the visitor support server 1 comprises a communication control unit 11, a task control unit 12, and a data storage unit 13.

The communication control unit 11 is constituted by, for example, a predetermined communication device such as a router, etc., and connects the visitor support server 1 to the communication network 3. For example, the communication control unit 11 exchanges various data (information) with the reception device 4 through the communication network 3.

The task control unit 12 performs communications through the communication control unit 11. Further, the task control unit 12 processes various information. The task control unit 12 comprises, for example, a CPU (Central Processing Unit), and performs various tasks by executing operation programs read out from the data storage unit 13.

The data storage unit 13 is constituted by a semiconductor memory, a magnetic disk recording device, or the like, and records various information and programs.

The visitor support database 2 shown in FIG. 1 is a database (DB) that stores various information on the visitor support system. As shown in FIG. 3, the visitor support database 2 comprises a reception information DB 21, a client information DB 22, a staff member information DB 23, an explanatory material information DB 24, an image information DB 25, and a handout information DB 26.

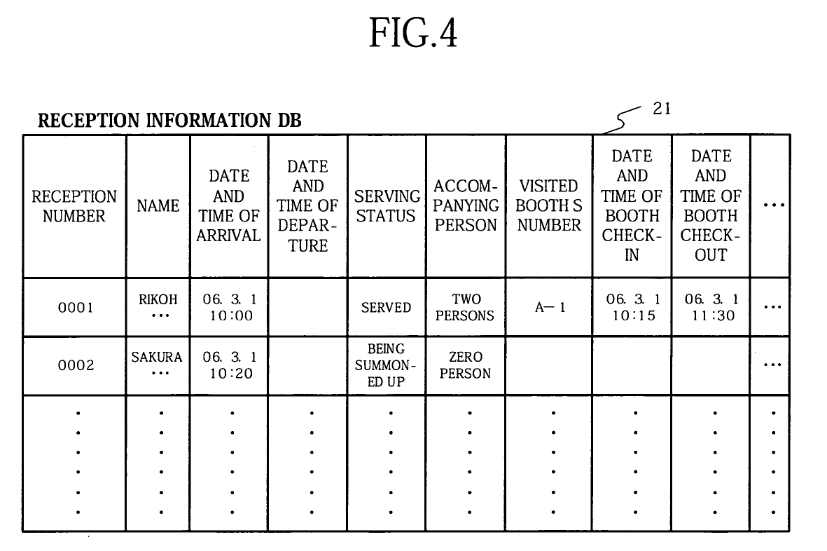

The reception information DB 21 is a database that stores information on the reception procedure for the clients who come to the site. For example, the reception information DB 21 stores reception number, client's name, date and time of arrival, date and time of departure, serving status, accompanying person, visited booth's number, date and time of booth check-in, date and time of booth check-out, etc., as shown in FIG. 4. Information on a visitor, such as the name of the client, etc. is read out from the RFID admission ticket with the use of, for example, the RFID handy reader 47 shown in FIG. 9, which is set up with the reception device 4. Date and time of arrival or date and time of departure are the date and time the RFID admission ticket is read by the RFID handy reader 47 when a visitor arrives at or leaves the site. Serving status shows the current status about summoning up a staff member in charge, and is marked as “being summoned up” indicating that a staff member is now being summoned up, or marked as “served” indicating that a staff member has already arrived at the reception and is serving the visitor, etc. Accompanying person indicates the number of accompanying persons who come to the site with the client. Visited booth's number indicates the number of the booth the visitor visited. Date and time of booth check-in or date and time of booth check-out indicate the date and time the visitor enters or leaves the booth. Visited booth's number, date and time of booth check-in, and date and time of booth check-out are recorded based on information on entry to or leave from the booth, which is sent from the booth terminal 6.

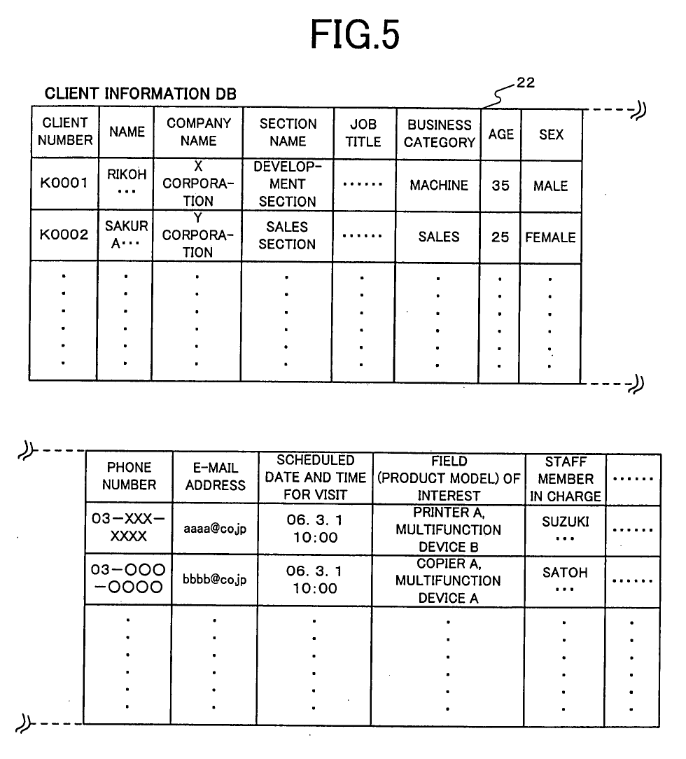

The client information DB 22 is a database that stores information on clients. The client information DB 22 stores, for example, client's number, name, company name, section name, job title, business category, age, sex, phone number, e-mail address, scheduled date and time for visit, field (product model) of interest, staff member in charge, etc., as shown in FIG. 5. Field of interest indicates the product model, etc. which the client is interested in. Staff member in charge indicates the salesperson, who is in charge of the client in question. The information on the client is registered in the client information DB 22 in a later-described registration task.

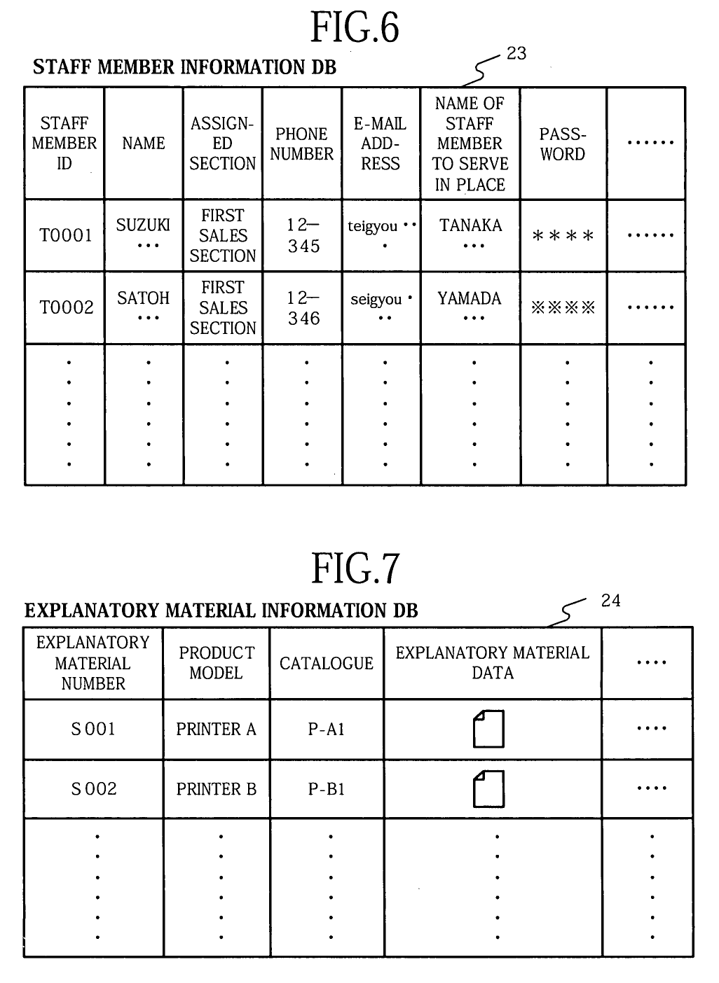

The staff member information DB 23 is a database that stores information on staff members in charge of sales, etc. The staff member information DB 23 stores, for example, staff member ID, name, assigned section, phone number, e-mail address, name of staff member to serve in place, password, etc., as shown in FIG. 6. Staff member ID is the identification information of the staff member. Registered as phone number is the extension number of the staff member in the case of a showroom or the like, or the portable phone number of the staff member in the case of an event site. Name of staff member to serve in place indicates the name of the staff member who will guide the client around in place of the intended staff member. Password is the password for the staff member to log in the visitor support system.

The explanatory material information DB 24 is a database that stores explanatory material information on explanatory materials about product models to be used when the client is guided around the event site. The explanatory material information DB 24 stores, for example, explanatory material number, product model, catalogue, explanatory material data, etc. as shown in FIG. 7.

The image information DB 25 is a database that stores information which builds up various images to be displayed in later-described tasks. Specifically, the image information DB 25 stores images of various materials for generating the images, forms of various types, etc. For example, the image information DB 25 stores information that constitutes an input screen from which a person responsible for each task enters necessary information.

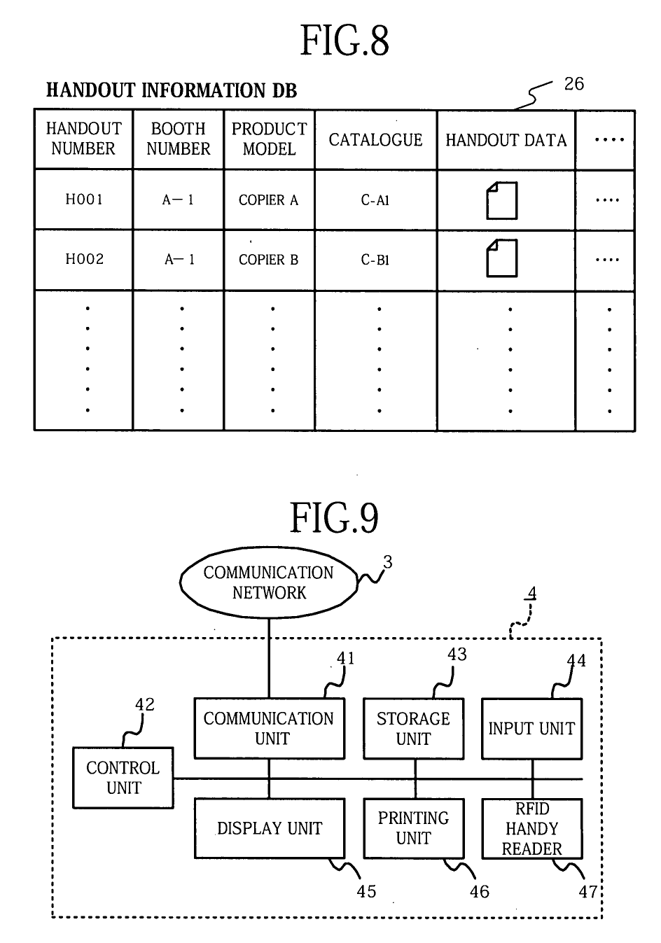

The handout information DB 26 is a database that stores handout information regarding materials to be handed to the visitors at each booth. The handout information DB 26 stores, for example, handout number, booth number, product model, catalogue, handout data, etc., as shown in FIG. 8.

The communication network 3 shown in FIG. 1 connects the visitor support server 1, the reception device 4, the staff member terminals 5, and the booth terminals 6 to one another, and relays data communications among them. In the present embodiment, the communication network 3 is such a communication network as the Internet, a LAN (Local Area Network), a WAN (Wide Area Network), etc. that is based on a predetermined communication protocol such as, for example, TCP/IP (Transmission Control Protocol/Internet Protocol), etc.

The reception device 4 shown in FIG. 4 is a device for processing tasks relating to the reception of a client who comes to the site with an admission ticket on him/her. The reception device 4 is set up at, for example, the entrance/exit of the event site, etc. As shown in FIG. 9, the reception device 4 comprises a communication unit 41, a control unit 42, a storage unit 43, an input unit 44, a display unit 45, a printing unit 46, and an RFID handy reader 47.

The communication unit 41 is constituted by a predetermined communication device such as, for example, a router or the like, and exchanges various data (information) with the visitor support server 1 through the communication network 3. For example, the communication unit 41 sends information on a visitor, which is read by the RFID handy reader 47, to the visitor support server 1. The communication unit 41 receives explanatory material data registered in the explanatory material information DB 24 from the visitor support server 1.

The control unit 42 is constituted by, for example, a CPU or the like, and controls the entire reception device 4. The control unit 42 performs various processes by activating predetermined applications pre-installed on the storage unit 43.

The storage unit 43 is constituted by a semiconductor memory, a magnetic disk storage device, or the like, and stores various information and programs.

The input unit 44 is constituted by a keyboard, a touch panel, etc., and accepts arbitrary data and information.

The display unit 45 comprises an output device such as an LCD (Liquid Crystal Display) or the like, and displays various information.

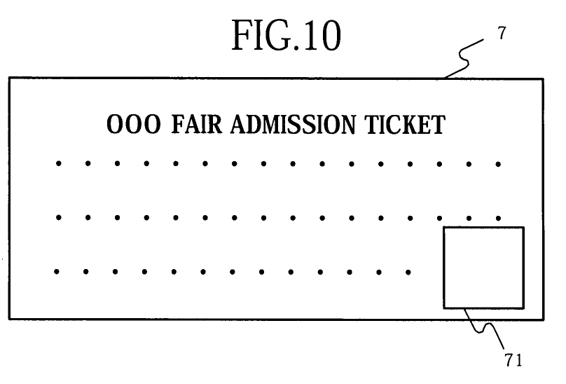

The printing unit 46 comprises a printing device that prints out predetermined data, etc. For example, the printing unit 46 prints out received explanatory material data or handout data, based on an instruction from the control unit 42. Preferably, the printing unit 46 is an RFID-compatible printer which can print an RFID admission ticket (an admission ticket in which an IC chip is embedded) as shown in FIG. 10, and can write information on a client into the IC chip 71. If the printing unit 46 is an RFID-compatible printer, an RFID admission ticket can easily be issued at the reception. Therefore, for example, even when the client brings with him/her a person who has not been scheduled to come, the task for afterward issuance of an RFID admission ticket for this accompanying person can easily be done.

The RFID handy reader 47 reads out information on a visitor from the RFID admission ticket possessed by the visitor, when the visitor arrives at or leaves the event site.

The staff member terminal 5 shown in FIG. 1 is constituted by, for example, a compute, a portable terminal, or the like, which has a communication function. For example, the staff member terminal 5 sends information on a client to the visitor support server 1. The staff member terminal 5 receives information regarding a correspondence message from the visitor support server 1.

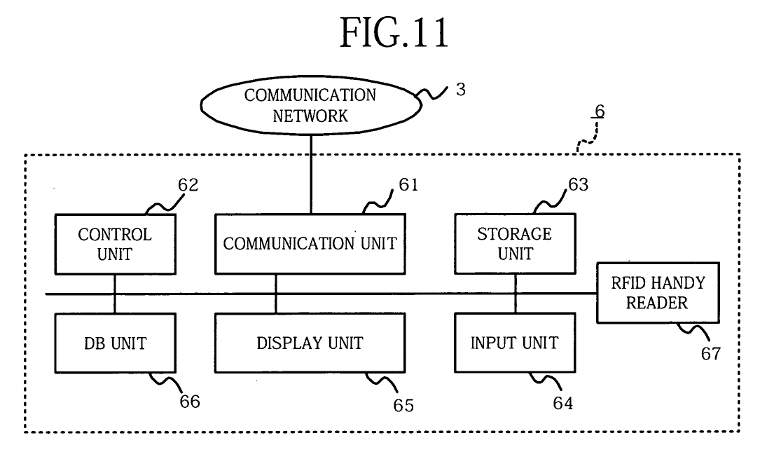

The booth terminal 6 shown in FIG. 6 is a device that processes tasks relating to the reception of a client who enters a booth. The booth terminal 6 is set up at, for example, the entrance/exit of each booth. FIG. 11 shows the structure of the booth terminal 6. As shown in FIG. 11, the booth terminal 6 comprises a communication unit 61, a control unit 62, a storage unit 63, an input unit 64, a display unit 65, a database (DB) unit 66, and a RFID handy reader 67.

The communication unit 61 is constituted by a predetermined communication device such as, for example, a router or the like, and exchanges various data (information) with the visitor support server 1 through the communication network 3. For example, the communication unit 61 sends information on a visitor read by the RFID handy reader 67 to the visitor support server 1. That is, information that a visitor has entered or left the booth in question (information on entry to or leave from a booth) is sent to the visitor support server 1. Then, the information on entry to or leave from the booth is registered in the reception information DB 21.

The control unit 62 is constituted by, for example, a CPU or the like, and controls the entire booth terminal 6. The control unit 62 performs various processes by activating predetermined applications pre-installed on the storage unit 63.

The storage unit 63 is constituted by a semiconductor memory, a magnetic disk recording device, or the like, ad stores various information and programs.

The input unit 64 is constituted by a keyboard, a touch panel, etc., and accepts arbitrary data and information.

The display unit 65 comprises an output device such as an LCD (Liquid Crystal Display) or the like, and displays various information.

The DB unit 66 comprises a booth reception information DB 661, a booth client information DB 662, a schedule information DB 663, and a demo information DB 664.

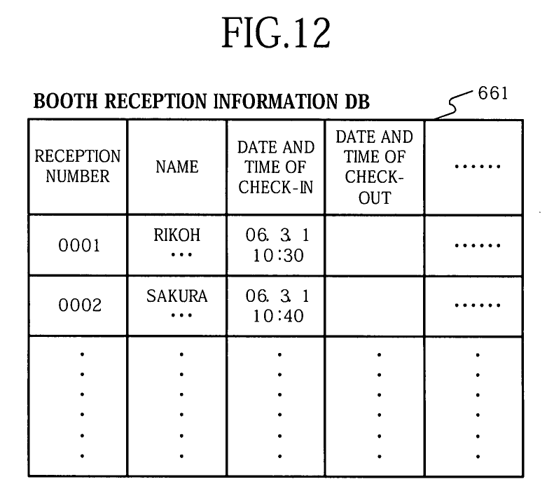

The booth reception information DB 661 is a database that stores information on an entry (reception) task for a visitor who visits the booth in question. The booth reception information DB 661 stores, for example, reception number, client's name, date and time of check-in, date and time of check-out, etc., as shown in FIG. 12. Information (reception information) that a visitor has entered the booth is generated from information regarding the visitor which is read in a later-described entry task by the booth terminal 6, and the generated reception information is registered in the booth reception information DB 661.

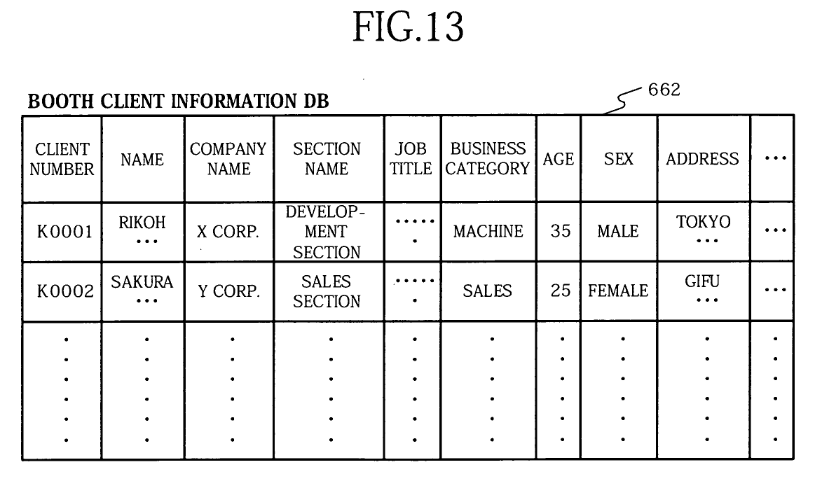

The booth client information DB 662 is a database that stores information on a client who visits the booth in question, such as the name of the client, etc. The booth client information DB 662 stores, for example, client number, name, company name, section name, job title, business category, age, sex, address, etc., as shown in FIG. 13. Information on a visitor, which is read in a later-described entry task by the booth terminal 6, is registered in the booth client information DB 662.

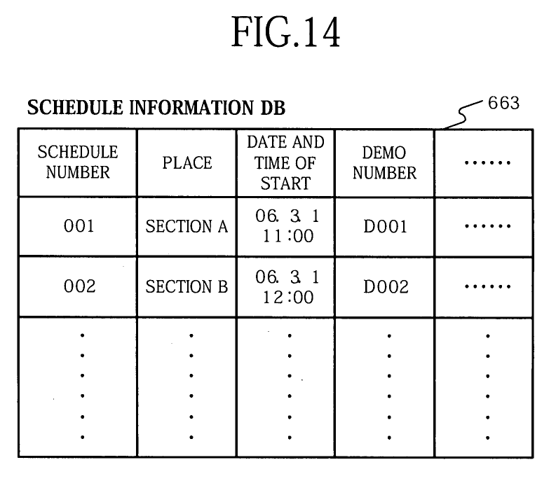

The schedule information DB 663 is a database that stores information on demo schedules. The schedule information DB 663 stores, for example, schedule number, place, date and time of start, demo number, etc., as shown in FIG. 14.

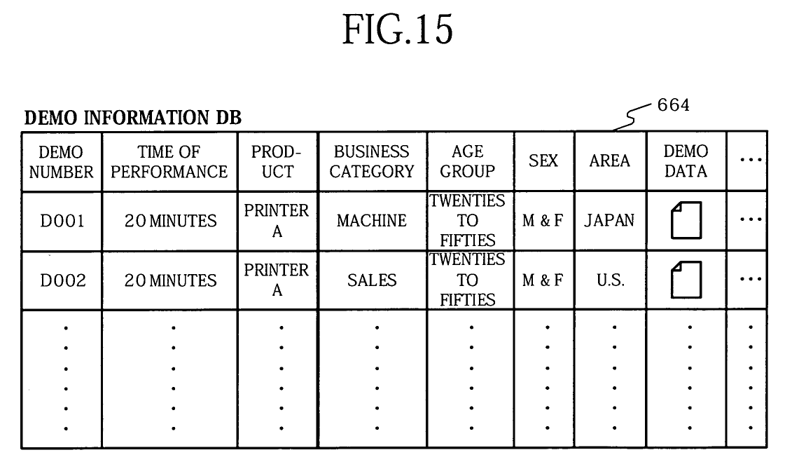

The demo information DB 664 is a database that stores information on demos. The demo information DB 664 stores, for example, demo number, time of performance, product, business category, age group, sex, area, demo data, etc., as shown in FIG. 15. Product indicates the product to be the object of the demo in question. Business category, etc. refer to the business category, etc. of the visitors who are the assumed audience of the demo. Demo data is sound data, image data, moving image data, or the like, for running the demo.

The RFID handy reader 67 shown in FIG. 11 reads information on a visitor, from the RFID admission ticket carried by the visitor, when the visitor enters the booth or leaves the booth.

Next, a visitor support method using the visitor support system having the above-described structure will be explained. Hereinafter, preliminary registration, login, registration task, admission task, booth entry/leave task, demo task, and departure task will be explained in this order.

(Preliminary Registration)

It is necessary to make a preliminary registration to the visitor support system to use the visitor support system. For example, in a case where a staff member makes a preliminary registration, first, the staff member sends information such as the name of the staff member, his/her assigned section, phone number, and e-mail address, the name of the staff member to serve in place, etc. to the visitor support server 1 from the staff member terminal 5 through the communication network 3. Upon receiving the information such as the name of the staff member, etc., the visitor support server 1 (task control unit 12) issues a staff member ID and a password, and sends the staff member ID and password to the staff member terminal 5 via, for example, an e-mail. The task control unit 12 registers the predetermined information received, and the staff member ID and password in the staff member information DB 23. Thus, the preliminary registration by the staff member is completed. The system may have an appointed administrator, and this administrator may perform preliminary registrations for staff members.

(Login)

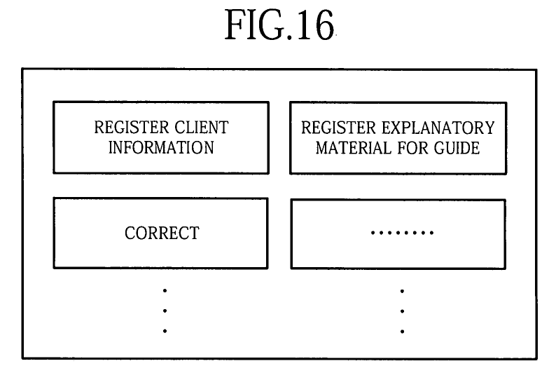

The staff member accesses a web site provided by the visitor support server 1 from the staff member terminal 5 through the communication network 3, and enters the ID (login name) and password received from the visitor support server 1 in the preliminary registration task. When the task control unit 12 of the visitor support server 1 identifies that the accesser is a staff member from the login name and password sent thereto, it reads out staff member menu page information (information in HTML format) as shown in FIG. 16 from the image information DB 25 and sends it to the staff member terminal 5 to display a staff member menu page on the staff member terminal 5. As shown in FIG. 16, menu item sections such as “register client information” for registering client information, “register explanatory material for guide” for registering explanatory material information, “correct” for correcting registered information, etc. are allocated on the staff member menu page. By selecting a predetermined menu item from the menu item sections by operating the staff member terminal 5, the staff member can perform a predetermined task.

(Registration Task)

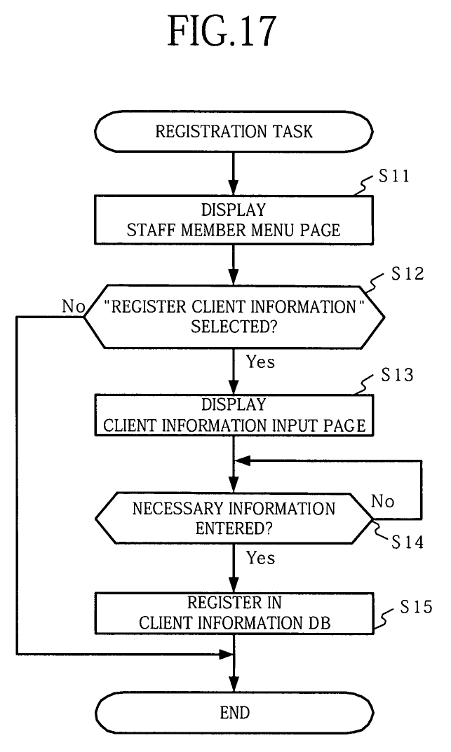

The registration task is a task for registering predetermined information in a predetermined database, such as registering client information in the client information DB 22, registering explanatory material information in the explanatory material information DB 24, registering handout information in the handout information DB 26, etc. In the present embodiment, the registration task will be explained in an example where client information is to be registered in the client information DB 22. FIG. 17 is a flowchart for explaining the registration task.

First, the task control unit 12 of the visitor support server 1 reads out the staff member menu page shown in FIG. 16 from the image information DB 25 and sends it to the staff member terminal 5, so that the staff member menu page may be displayed on the staff member terminal 5 (step S11). Next, the task control unit 12 determines whether or not “register client information” on the staff member menu page is selected (step S12). That is, the task control unit 12 determines whether or not the staff member clicks “register client information” from the staff member menu page.

In a case where it is determined that “register client information” is not selected (step S12; No), the task control unit 12 terminates this task. In a case where it is determined that “register client information” is selected (step S12; Yes), the task control unit 12 reads out an unillustrated input page from the image information DB 25 and sends it to the staff member terminal 5 to display a client information input page on the staff member terminal 5 (step S13). The staff member operates the staff member terminal 5 to enter the name, company name, section name, job title, phone number, e-mail address, scheduled date and time for visit, field (product model) of interest, etc. of the client who is to come, and sends the entered information to the visitor support server 1.

Then, the task control unit 12 of the visitor support server 1 determines whether or not necessary information has been entered (step S14). In a case where it is determined that necessary information has not been entered (step S14; No), the task control unit 12 notifies this to the staff member terminal 5 and waits until necessary information is input. In a case where it is determined that necessary information has been entered (step S14; Yes), the task control unit 12 registers the entered client information in the client information DB 22 (step S15), and terminates this task.

Through a similar process, the staff member can register explanatory material information and handout information in the explanatory material information DB 24 and the handout information DB 26 by operating the staff member terminal 5. This registration task may be performed by the aforementioned administrator of the system.

(Admission Task)

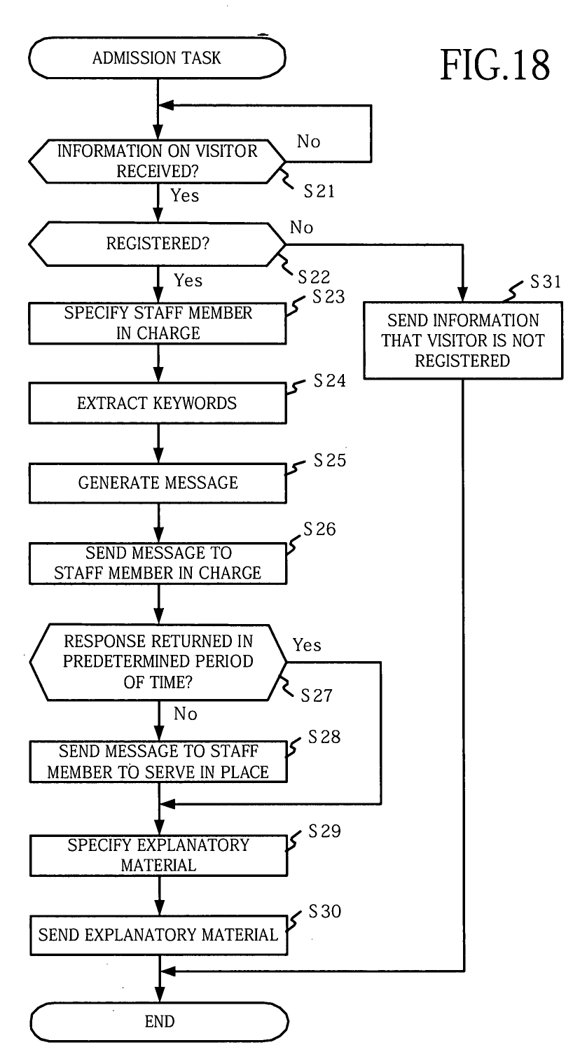

The admission task is a task for admitting a visitor at the reception based on the information on the visitor read from the RFID admission ticket of the client. It is also in this admission task, when the staff member in charge of the visitor (client) is summoned up. FIG. 18 is a flowchart for explaining the admission task.

First, the task control unit 12 of the visitor support server 1 determines whether or not it has received information on a visitor who has come to the site from the reception device 4 (step S21). At the reception, admission management is done by reading the RFID admission ticket brought by the visitor with the use of the RFID handy reader 47 set with the reception device 4. When the RFID admission ticket of the client is read by the RFID handy reader 47, for example, the control unit 42 of the reception device 4 displays the read information about the visitor on the display unit 45. In a case where the visitor brings no company, the receptionist operates the input unit 44 and clicks “send” key to send the information on the visitor to the visitor support server 1. In a case where the visitor brings any accompanying person with him/her, the receptionist enters the number of accompanying persons, clicks “send” key to send the information on the visitor to the visitor support server 1, and issues an RFID ticket for the accompanier. Thereby, the information on the visitor is sent from the reception device 4 to the visitor support server 1.

In a case where it is determined that information on a visitor who has come to the site has been received from the reception device 4 (step S21; Yes), the task control unit 12 of the visitor support server 1 registers the client name and the date and time of arrival in the reception information DB 21, and determines whether or not the admitted visitor is registered in the client information DB 22 (step S22). In a case where it is determined that the visitor is not registered in the client information DB 22 (step S22; No), the task control unit 12 sends information that the visitor is not registered in the client information DB 22 to the reception device 4 (step S31), and terminates this task. In this case, at the reception, a task for issuing an RFID admission ticket for this visitor will be performed.

In a case where it is determined that the visitor is registered in the client information DB 22 (step S22; Yes), the task control unit 12 of the visitor support server 1 specifies the staff member, who is in charge of this visitor (client), from the information registered in the client information DB 22 (step S23).

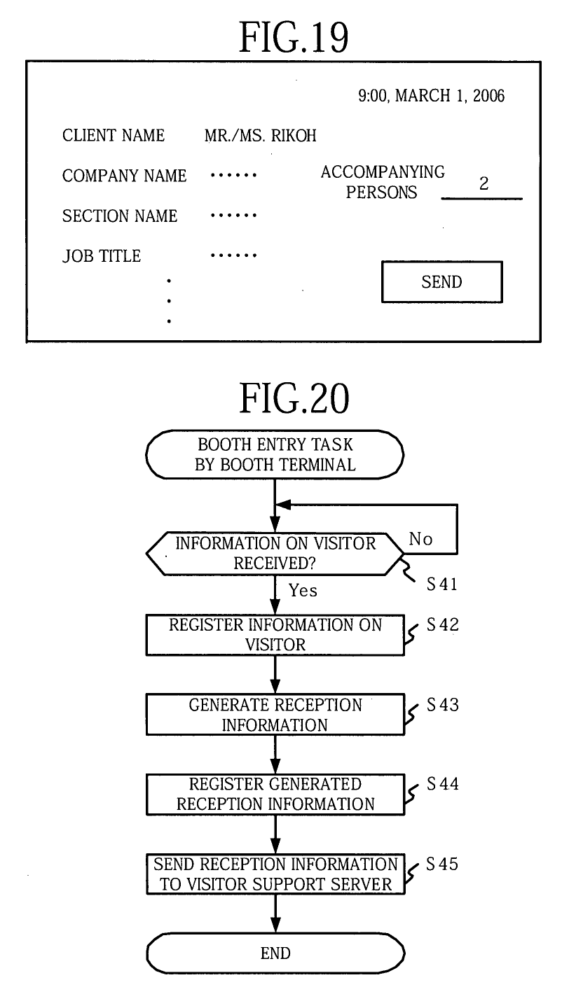

Next, the task control unit 12 of the visitor support server 1 extracts keywords from the information on the visitor received from the reception device 4 (step S24). Anything that can identify the client, or anything that represents the circumstance when the visitor arrives, etc. are extracted as keywords. For example, in a case where information on a visitor, which is as shown in FIG. 19, is received, the task control unit 12 extracts the client name “Rikoh . . . ”, the company name “ . . . ”, the date and time of arrival “2006, Mar. 1, 9:00”, the number of accompanying persons “2”, etc. as keywords.

Next, the task control unit 12 of the visitor support server 1 generates a correspondence message for notifying the visitor's arrival to the staff member in charge, by incorporating the extracted keywords into a template message (step S25). For example, in the aforementioned case, a correspondence message like “Mr./Ms. Rikoh . . . from . . . corporation arrived at 9:00, Mar. 1, 2006 with two accompanying guests. Your appearance at the reception is required.” is generated.

Then, the task control unit 12 of the visitor support server 1 sends the generated correspondence message to the staff member terminal 5 (for example, a portable terminal of the staff member) of the staff member in charge specified at step S23 (by e-mail, for example) (step S26). Then, the task control unit 12 registers “being summoned up” as the serving status of the visitor (client) in the reception information DB 21.

Next, the task control unit 12 of the visitor support server 1 determines whether or not any response has been returned from the staff member in charge before a predetermined time passes (step S27). In a case where it is determined that a response has been returned from the staff member before the predetermined time passes (step S27; Yes), the task control unit 12 proceeds to step S29. In a case where it is determined that no response has been returned from the staff member before the predetermined time passes (step S27; No), the task control unit 12 specifies the staff member to serve in place registered in the staff member information DB 23, and sends the correspondence message to the staff member terminal 5 of the specified staff member (step S28).

Subsequently, the task control unit 12 of the visitor support server 1 specifies the explanatory material for a product model, which is to be used for guiding the client, based on the field (product model) of interest of the visitor (client) registered in the client information DB 22 (step S29). In the present example, the field (product model) that interests the visitor (client), which is registered in the client information DB 22, is specified, and the explanatory material for the specified field (product model) of interest is specified from the explanatory material DB 24.

Next, the task control unit 12 of the visitor support server 1 sends the guide material data on the product model specified to the reception device 4 (step S30), and terminates this task.

At the reception, the control unit 42 of the reception device 4 controls the printing unit 46 to print the received explanatory material data for the number of copies that covers the client and his/her accompaniers (three copies, in the aforementioned example). Further, the control unit 42 controls the printing unit 46 to issue RFID admission tickets for the accompanying persons. Thus, the explanatory material to be used for guiding the client, which covers all the visitors involved, can be prepared available to the summoned staff member when he/she arrives at the reception to welcome the visitors who have come to the site. Further, the staff member in charge can hand the RFID admission tickets to the accompanying persons.

The reception procedure at the reception is thus completed, and the control unit 42 of the reception device 4 sends information that the reception procedure has been completed to the visitor support server 1. When the information that the reception procedure has been completed is received from the control unit 42, the task control unit 12 of the visitor support server 1 registers “served” as the serving status of the visitor (client) in the reception information DB 21.

As described above, since the task control unit 12 of the visitor support server 1 specifies the staff member in charge, and sends the correspondence message to the staff member terminal 5 of the specified staff member, the task load at the reception can be reduced. Therefore, the tasks relating to the reception of the visitor can be facilitated. Furthermore, the waiting time of the client can be shortened.

Further, since the task control unit 12 of the visitor support server 1 generates the correspondence message by extracting keywords (for example, the number of accompanying persons of the visitor) that correspond to the situation when the visitor arrives, it is possible to generate a correspondence message that matches the arrival situation. Further, since the task control unit 12 sends the explanatory material data to the reception device 4, the explanatory material used for guiding the client can be easily prepared. Particularly, even when the number of copies required increases, this can easily be coped with.

(Booth Entry/Leave Task)

The booth entry/leave task is a task executed by the booth terminal 6 and the visitor support server 1, when the RFID admission ticket is read by the RFID handy reader 67 set up with the booth terminal 6 when the visitor enters or leaves a booth. By this task, information that a visitor has entered or left a predetermined booth is registered in the visitor support server 1. FIG. 20 is a flowchart for explaining the booth entry/leave task by the booth terminal 6. The following explanation will be given in an example where a visitor has come to a booth.

The control unit 62 of the booth terminal 6 determines whether or not it has received information on a visitor (step S41). That is, the control unit 62 determines whether or not any visitor has entered the booth. Specifically, the control unit 62 determines whether or not any visitor to the booth has his/her RFID admission ticket read by the RFID handy reader 67 set up with the booth terminal 6 at the entrance/exit of the booth. In a case where it is determined that information on a visitor has been received (step S41; Yes), the control unit 62 stores the received information on the visitor in the booth client information DB 662 (step S42).

Next, the control unit 62 of the booth terminal 6 generates information (reception information) that a visitor has entered, from the received information on the visitor (step S43). This reception information includes information such as the name, etc. of the visitor, extracted from the received information on the visitor, and information indicating the date and time (date and time of booth check-in) at that time. Then, the control unit 62 registers the generated reception information in the booth reception information DB 661 (step S44). Then, the control unit 62 sends the registered reception information to the visitor support server 1 (step S45), and terminates this task.

In a case where the visitor leaves the booth, the same task is executed, except that the information on the visitor read by the RFID handy reader 67 is not stored in the storage unit 63 and that reception information, in which the date and time at that time are recorded as the date and time of booth check-out, is generated.

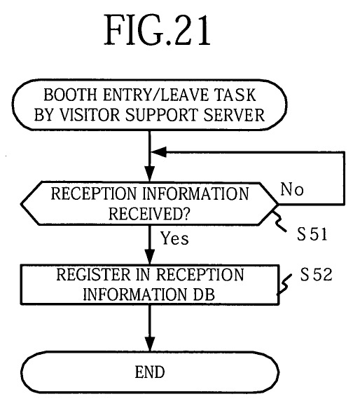

FIG. 21 is a flowchart for explaining the booth entry/leave task by the visitor support server 1.

The task control unit 12 of the visitor support server 1 determines whether or not it has received information (reception information) on entry/leave into or from the booth from the booth terminal 6 (step S51). In a case where it is determined that reception information has been received (step S51; Yes), the task control unit 12 registers the received reception information in the reception information DB 21 (step S52). That is, the task control unit 12 registers the visited booth number, and the date and time of booth check-in or the date and time of booth check-out in the record having the name of the corresponding visitor in the reception information DB 21. Then, the task control unit 12 terminates this task. Thus, the visitor support server 1 can register when, in which booth, and how long the visitor stayed. The use of this reception information can help reduce the load required in compilation tasks, for example, tasks of the staff members, etc. (report writing, etc.), and can contribute to post-event sales activities such as writing and sending messages to express thanks for the visit.

(Demo Task)

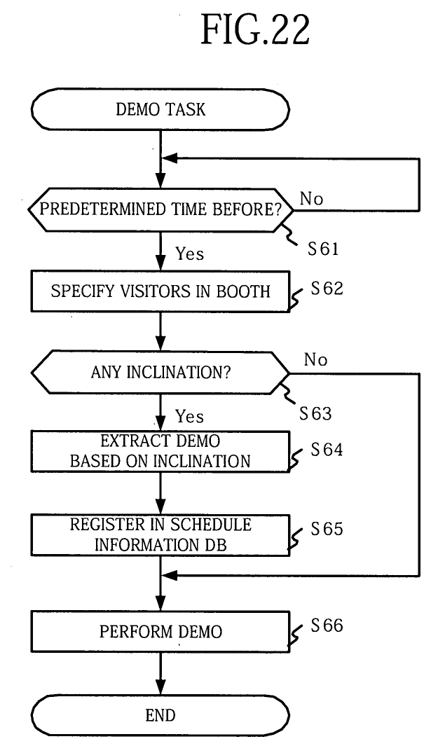

The demo task is a task for selecting the content of a demo that matches the visitor who enters the booth, and performing the selected demo. FIG. 22 is a flowchart for explaining the demo task.

First, the control unit 62 of the booth terminal 6 determines whether or not the current time is a predetermined time before the demo is started (step S61). In a case where it is determined that the current time is the predetermined time before (step S61; Yes), the control unit 62 specifies the visitors who are currently in the booth, from the information stored in the booth reception information DB 661 (step S62). For example, the control unit 62 may specify the records in which the date and time of booth check-in are registered but the date and time of booth check-out are not registered, as the records that concern the visitors currently in the booth, among the records stored in the booth reception information DB 661.

Then, the control unit 62 of the booth terminal 6 determines whether or not the visitors specified as currently being in the booth have a predetermined inclination (step S63). Here, a predetermined inclination means that visitors from a predetermined business category, age, sex, area, or the like. account for the visitors currently in the booth, at equal to or greater than a predetermined percentage. For example, in a case where visitors from a predetermined business category account for the half or greater of all the visitors, the control unit 62 determines that the visitors have an inclination. The control unit 2 determines the presence or absence of an inclination based on the contents registered in the booth reception information DB 661 and the booth client information DB 662. In a case where it is determined that the visitors have no inclination (step S63; No), the control unit 62 proceeds to step S66.

In a case where it is determined that the visitors have an inclination (step S3; Yes), the control unit 62 of the booth terminal 6 extracts a demo that is based on the inclination, from the demos registered in the demo information DB 664 (step S64).

For example, as shown in FIG. 15, assume that two demos (demo number “D001” and “D002”) whose product index indicates “printer A” are registered in the demo information DB 664, and the business category of the demo number “D001” is “machine” while the business category of the demo number “D002” is “sales”. In a case where the half or more of the visitors in the booth are from the business category “sales” under such a status in the demo information DB 664, the control unit 62 of the booth terminal 6 extracts the demo number “D002” as the demo about “printer A”, that is to be performed in this booth.

Next, the control unit 62 of the booth terminal 6 registers the demo extracted at step S64 in the schedule information DB 663 (step S65).

For example, assume that the demo information DB 664 is in such a status as described above shown in FIG. 15, and as shown in FIG. 14, a place “section A”, a start time “2006. 0301 11:00”, and the demo number “D001” are registered at the schedule number “001” in the schedule information DB 663. In a case where the half or more of the visitors that are present the predetermined time before the start time are from the business category “sales” under such a status, the control unit 62 of the booth terminal 6 changes the demo (demo number) of the schedule number “001” to “D002”.

Then, the control unit 62 performs the demo stored in the demo information DB 664 according to the schedule registered in the schedule information DB 663 (step S66), and terminates this task.

According to this demo task, the control unit 62 of the booth terminal 6 changes the content of the demo according to the inclination in the visitors that are in the booth currently. Therefore, it becomes easier for the visitors to understand the product, and easier for the visitors to be interested. As apparent from this, it is possible to perform a demo that matches the visitors and support the visitors.

(Departure Task)

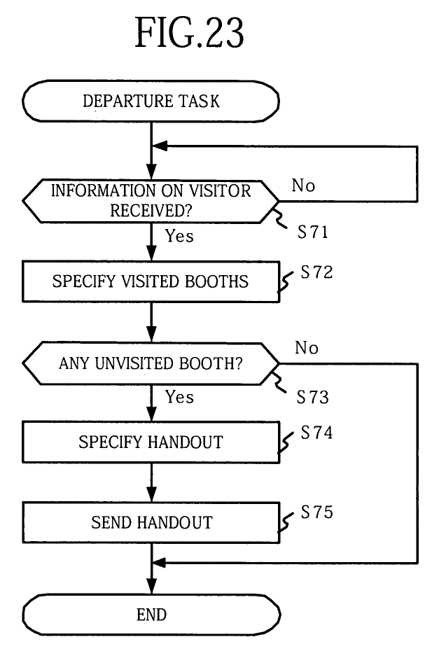

The departure task is a task that handles the departure of a visitor at the reception, based on information on the visitor read from the RFID admission ticket of the client. In this departure task, the visitor is provided with materials that were distributed at booths which the visitor could not visit. FIG. 23 is a flowchart for explaining the departure task.

First, the task control unit 12 of the visitor support server 1 determines whether or not it has received information on a visitor (departing visitor) who is to leave the site from the reception device 4 (step S71). That is, the task control unit 12 determines whether or not the departure of any visitor has been checked at the reception by the RFID admission ticket brought by the visitor being read by the RFID handy reader 47 set up with the reception device 4 and the information on the visitor has been sent from the reception device 4 to the visitor support server 1. In a case where it is determined that information on a visitor (departing visitor) who is to depart has been received from the reception device 4 (step S71; Yes), the task control unit 12 of the visitor support server 1 registers the date and time of departure in the record showing the client name of the departing visitor whose departure has been checked in the reception information DB 21, and specifies the booths that the departing visitor has visited (step S72). The booths visited by the departing visitor may be specified from the visited booth's numbers in the record of this departing visitor in the reception information DB 21.

Next, the task control unit 12 of the visitor support server 1 determines whether or not there is any unvisited booth that has not been visited by the visitor who is to leave (step S73). In the present example, unvisited booths are distinguished based on the field (product model) of interest registered in the client information DB 22. Specifically, the control unit 12 specifies booths that feature the field (product model) of interest registered in the client information DB 22, based on the booth numbers and product models registered in the handout information DB 26, and determines whether or not there is any unvisited booth from the specified booths and the booths specified at step S72 as having been visited by the visitor. In a case where it is determined that there is no unvisited booth (step S73; No), the task control unit 12 terminates this task.

In a case where it is determined that there is any unvisited booth (step S73; Yes), the task control unit 12 of the visitor support server 1 specifies the handouts that were distributed at such unvisited booths (step S74). That is, the task control unit 12 specifies handouts that are about the product model registered in the client information DB 22, among the handouts that were distributed at unvisited booths.

Next, the task control unit 12 of the visitor support server 1 acquires the handout data of the handouts specified at step S74, and sends the handout data to the reception device 4 (step S75). Thereby, this task is completed.

Thereafter, at the reception, the control unit 42 of the reception device 4 controls the printing unit 46 to print the received handout data for, for example, the number of copies that covers the client and his/her accompaniers (in the aforementioned example, three copies). Hence, the client can obtain the handouts of the unvisited booths. The client can therefore further obtain information about the product model of his/her interest. Further, the staff member in charge can gain food for thought for the future sales activities, and expect expansion of the range of business.

As explained above, according to the present embodiment, since a correspondence message corresponding to the situation when the visitor arrives at the event site is sent to the staff member in charge in the admission task when the visitor is to enter the event site, the tasks relating to the reception of the visitor can be facilitated. Accordingly, it is possible to provide a system, etc. which can support the tasks relating to the reception of the visitors.

Further, according to the present embodiment, the content of the demo is changed according to the inclination of the visitors that are currently in a booth. Therefore, the product can better be understood by the visitors, and can better attract the visitors. By performing a demo that matches the visitors, it is possible to provide a system, etc. that can support the visitors.

Furthermore, according to the present embodiment, since the visitor is offered handouts about the product model (product) the visitor is interested in, that were distributed at booths which the visitor has not visited in the departure task when the visitor is to leave the event site, it is possible to provide information which the visitor has missed. Hence, it is possible to provide a system, etc. that can support the visitors.

The present invention is not limited to the above-described embodiment, but can be modified and applied in various manners.

For example, in generating a correspondence message in the admission task, the visitor support server 1 may add the scheduled date and time for visit of the client registered in the client information DB 22 to the correspondence message. For example, in the aforementioned case, as the scheduled date and time for visit of the client is 10:00, Mar. 1, 2006 as shown in FIG. 4, the visitor support server 1 may generate a correspondence message “Mr./Ms. Rikoh . . . from . . . corporation, who is scheduled to come at 10:00, Mar. 1, 2006, arrived at 9:00, Mar. 1, 2006 with two accompanying guests. Your appearance at the reception is required.”.

In the above-described embodiment, the present invention was explained in an example where the correspondence message generated by the visitor support server 1 in the admission task is sent (by e-mail) to the staff member terminal 5 of the staff member (for example, a portable terminal of the staff member). However, the correspondence message is not limited to character information to be sent by e-mail, but may be a correspondence message made of sound information. In this case, the visitor support server 1 comprises a sound generating unit which generates a sound from character information, and the generated sound (correspondence message) is sent to the telephone, for example, a portable telephone or the like of the staff member in charge.

In the above-described embodiment, the present invention was explained in an example where the reception device 4 displays information on the visitor read by the RFID handy reader 47 on the display unit 45 in the admission task, so that the number of accompanying persons may be entered at the reception. However, for example, the reception device 4 may not display the read information on the visitor on the display unit 45, but simply send it to the visitor support server 1. In this case, the task load at the reception can further be reduced, facilitating the tasks relating to the reception of the visitor.

In the above-described embodiment, the present invention was explained in an example where the RFID admission ticket is used. However, for example, QR code or active tag may be used instead of the RFID admission ticket. For example, in a case where QR code is used, it is possible to obtain information on a visitor by simply letting the visitor pass the gate or the like.

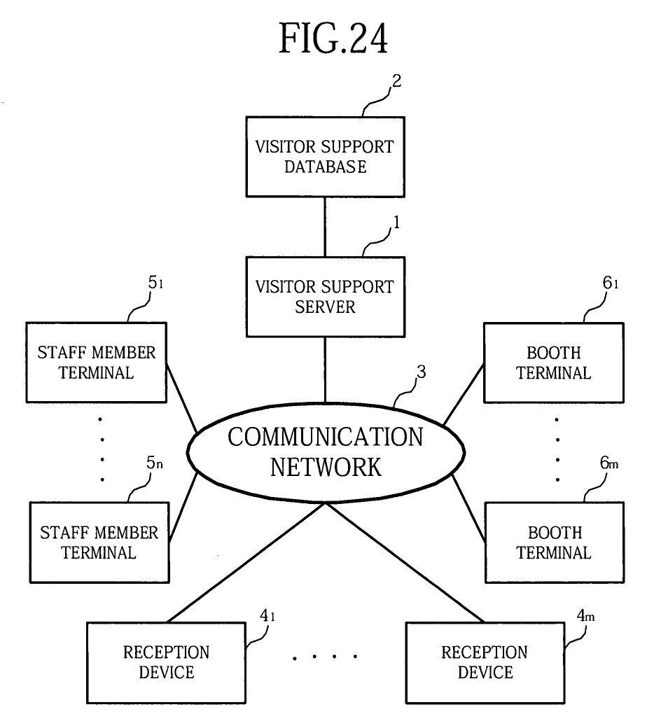

In the above-described embodiment, the present invention was explained in an example where there is only one reception device 4. However, for example, as shown in FIG. 24, there may be a plurality of reception devices 4 (4₁ to 4ₘ). In this case, in the admission task, the visitor support server 1 shall designate a device number for specifying any reception device 4, when it is to send explanation material data. Further, in the admission task, the correspondence message generated by the visitor support server 1 shall indicate any reception number at which the visitor will be picked up.

In the above-described embodiment, the present invention was explained in an example where the visitor support server 1 specifies a staff member to serve in place registered in the staff member information DB 23 when there is no response from the original staff member in charge before a predetermined time passes, and sends the correspondence message to the staff member terminal 5 of the specified staff member to serve in place. However, for example, the visitor support server 1 may send the generated correspondence message to the staff member terminals 5 of both the staff member in charge and the staff member to serve in place without waiting for a predetermined time to pass, so that both the staff members may get in contact with each other to decide who is to be in charge of the client. In this case, it is possible to further shorten the waiting time of the client.

In the above-described embodiment, the present invention was explained in an example where the booth terminal 6 changes the content of the demo according to the inclination among the visitors who are currently in the booth in the demo task. However, the booth terminal 6 may change the content of the demo based on information on the visitors who are currently in the booth.

Further, instead of changing the content of the demo, the booth terminal 6 may change, for example, the narration, the background, the BGM, etc. of the demo to be played. Furthermore, instead of changing the content of the demo, the booth terminal 6 may change the product to be demonstrated, or change the place of the demo. In any of these case too, it is possible to make the visitors interested in the product and support the visitors.

In the above-described embodiment, the present invention was explained in an example where the DB unit 66 of the booth terminal 6 has the booth reception information DB 661, etc., and the control unit 62 of the booth terminal 6 changes the content of the demo by determining the inclination of the visitors. However, for example, the task control unit 12 of the visitor support server 1 may determine the inclination of the visitors and change the content of the demo.

In the above-described embodiment, the preset invention was explained in an example where the staff member in charge of sales, etc. is notified that a client has arrived at the event site, so that the staff member may guide the client. However, no staff member may guide the visitor, but the visitor him/herself may see around the booths without guide. Also in this case, since the handouts about the product model the visitor is interested in, that were distributed at the booths which the visitor has not visited, are distributed from the reception device 4 in the departure task, it is possible to provide information which the visitor has missed.

Further, for example, the visitor support server 1 may accumulate a point each time a visitor visits a booth, and provide a coupon or the like that can be used inside or outside the event site when the visitor has accumulated a predetermined number of points or more. This makes it possible to promote visits to the booths.

In the above-described embodiment, the present invention was explained in an example where the visitor support serve 1 determines unvisited booths based on the field (product model) of interest registered in the client information DB 22. However, for example, the staff member in charge may register the numbers (recommended booth's numbers) of recommended booths which the staff member encourages the client to visit in the client information DB 22, and the visitor support server 1 may determine unvisited booths based on whether or not the client has visited the recommended booths. Further, the visitor support server 1 may take the booth stay time into consideration, and add booths that were stayed at for a short time, among unvisited booths. Furthermore, the visitor support server 1 may control the display unit 45 of the reception device 4 to display a list of unvisited booths or handouts distributed at unvisited booths, etc. so that the client him/herself can select handouts that interest him/her, by, for example, selecting any handouts from this list.

In the above-described embodiment, the present invention was explained in an example where the staff member registers the product model, etc. of interest of the client. However, for example, the client him/herself may set the product model, etc. of his/her interest, by accessing a web site provided by the visitor support server 1, declaring his/her interest at the reception when the client arrives at the event site, etc. In this case, if the administrator or the like of the system registers the client's interest in the client information DB 21, the same merits can be enjoyed.

In the above-described embodiment, the present invention was explained in an example where the visitor support server 1 specifies unvisited booths, specifies handouts, ad sends the handout data to the reception device 4. However, the visitor support server 1 may at least need to specify unvisited booths, and needs not to, for example, send handout data to the reception device 3. This is because, as long as unvisited booths are specified, the staff member in charge can generate handouts about the interest of the client, by operating the staff member terminal 5 on a later day. Then, the staff member can provide the handouts about the interest of the client to the client by mail, in person, etc.

The visitor support server 1 according to the embodiment of the present invention can be realized not by a dedicated system but by an ordinary computer system. For example, it is possible to build up the visitor support server 1 that executes the above-described tasks, by installing a program for realizing the tasks on a general-purpose computer from a recording medium (a flexible disk, a CD-ROM, etc.) that stores the program.

The means for providing the program is arbitrary. The program can be provided via a predetermined recording medium as described above, or, for example, may be provided via a communication line, a communication network, a communication system, etc. In this case, for example, the program may be posted to a bulletin board system (BBS) on a communication network to be embedded on a carrier wave and provided via the network. Then, by activating the program provided in such a way and executing the program under an OS (Operating System) as executing other application programs, it is possible to perform the above-described tasks.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2006-075690 filed on Mar. 17, 2006, Japanese Patent Application No. 2006-077039 filed on Mar. 20, 2006, and Japanese Patent Application No. 2006-077043 filed on Mar. 20, 2006 and including specification, claims, drawings and summary. The disclosures of the above Japanese Patent Applications are incorporated herein by reference in their entireties.

What is claimed is:

1. A visitor support system, comprising:
a prospective visitor information storage unit which stores information for specifying a prospective visitor who has a possibility of coming to a site and staff member specifying information for specifying a staff member who is to be in charge of the prospective visitor in association with each other;
a visitor information receiving unit which receives information for specifying a visitor who is checked at a reception, from a terminal device at the reception at which visitors are checked;
a staff member acquiring unit which acquires the staff member specifying information that specifies a staff member to be in charge of the visitor checked at the reception, based on the information for specifying the visitor received by said visitor information receiving unit, and the information stored in said prospective visitor information storage unit;
a correspondence message generating unit which generates a correspondence message for notifying that the visitor who is specified by the information for specifying the visitor received by said visitor information receiving unit has arrived at the site; and
a correspondence message sending unit which sends the correspondence message generated by said correspondence message generating unit to an address previously assigned to the staff member specified by the staff member specifying information acquired by said staff member acquiring unit.

2. The visitor support system according to claim 1, further comprising
a visitor status receiving unit which receives status information indicating a visit status of the checked visitor, from said terminal device at the reception,
wherein said correspondence message generating unit generates a correspondence message for notifying the status indicated by the status information received by said visitor status receiving unit.

3. The visitor support system according to claim 2,
wherein the status information is information indicating a number of accompanying persons who accompany the checked visitor.

4. The visitor support system according to claim 1,
wherein said prospective visitor information storage unit further stores information for specifying a product which a prospective visitor, who is stored, is interested in, in association with the information for specifying the prospective visitor, and
said visitor support system further comprises:
a product explanatory material storage unit which stores the information for specifying the product and data of an explanatory material for explaining the product in association with each other;
a product-of-interest specifying unit which specifies a product which the checked visitor is interested in, based on the information stored in said prospective visitor information storage unit;
a product explanatory material acquiring unit which acquires data of an explanatory material for explaining the product specified by said product-of-interest specifying unit, from said product explanatory material storage unit;
an explanatory material sending unit which sends the data acquired by said product explanatory material acquiring unit to said terminal device at the reception; and
an explanatory material printing unit which prints the explanatory material by using the data sent from said explanatory material sending unit.

5. The visitor support system according to claim 1,
wherein in a case where no response to the correspondence message is returned from the staff member who is an addressee of the correspondence message within a predetermined period of time after the correspondence message is sent, said correspondence message sending unit sends the correspondence message to a staff member to serve in place, who is pre-associated with the staff member.

6. The visitor support system according to claim 1, which is for supporting a visitor, who has come to a predetermined site having a plurality of booths, in seeing around the site,
wherein said prospective visitor information storage unit further stores attribute information indicating an attribute of a prospective visitor, who is stored, in association with the stored information for specifying the prospective visitor, and
said visitor support system further comprises:
a booth entry/leave information storage unit which stores information for specifying a visitor who enters any predetermined one of the booths, and entry/leave information indicating dates and times of entry and leave the visitor enters and leaves the booth, in association with each other;
a booth visitor specifying unit which specifies visitors who are in the predetermined booth, based on the information stored in said booth entry/leave information storage unit;
an attribute information specifying unit which specifies the attribute information of the visitors who are in the predetermined booth, specified by said booth visitor specifying unit, based on the information stored in said prospective visitor information storage unit;
a demo specifying unit which specifies a demo to be performed in the booth, based on the attributed information specified by said attribute information specifying unit; and
a demo performing unit which performs the demo specified by said demo specifying unit.

7. The visitor support system according to claim 6,
wherein said demo specifying unit comprises an inclination determining unit which determines whether the attributes indicated by the attribute information specified by said attribute information specifying unit have a predetermined inclination, and
in a case where said inclination determining unit determines that the attributes have a predetermined inclination, said demo specifying unit specifies a demo according to the predetermined inclination.

8. The visitor support system according to claim 6,
wherein said demo specifying unit specifies at least one of a product to be demonstrated, a content of the demo, and a place at which the demo is performed.

9. The visitor support system according claim 7, further comprising
a demo information storage unit which stores data of a demo to be performed in any predetermined booth, and inclination information indicating an inclination of attributes of visitors, for which the demo is expected to be effective, in association with each other,
wherein in a case where inclination determining unit determines that the attributes have a predetermined inclination, said demo specifying unit specifies data of a demo which matches the predetermined inclination, from the information stored in said demo information storage unit.

10. The visitor support system according to claim 7,
wherein the attribute information includes at least one of information pieces indicating a business category, age, sex, and residence area of a visitor, and
said inclination determining unit determines that visitors have a predetermined inclination, when there is a certain bias in business categories, ages, sexes, or residence areas of the visitors, which are indicated by the attribute information specified by said attribute information specifying unit.

11. The visitor support system according to claim 1, which is for supporting a visitor, who has come to a predetermined site having a plurality of booths, in seeing around the site, said system further comprising:
a booth visitor information receiving unit which receives information for specifying a visitor who is checked by a terminal device which checks visitors who are to enter any of the booths, and a booth specifying information for specifying a booth entered by the visitor, from said terminal device;
a booth visitor storage unit which stores the information for specifying the visitor and the booth specifying information, which are received by said booth visitor information receiving unit, in association with each other;
a departing person information receiving unit which receives information for specifying a departing person, who is checked by said terminal device at the reception at which departing persons who are to leave the predetermined site are checked, from said terminal device;
an unvisited booth specifying unit which specifies a booth which has not been visited by the departing person, from the information for specifying the departing person received by said departing person information receiving unit and the information stored in said booth visitor storage unit; and
a display unit which displays the booth specified by said unvisited booth specifying unit as not having been visited.

12. The visitor support system according to claim 11, comprising:
a handout storage unit which stores the booth specifying information for specifying a booth, and data of a handout distributed at the booth, in association with each other;
a handout extracting unit which extracts data of a handout distributed at the booth specified by said unvisited booth specifying unit, from data of handouts stored in said handout storage unit;
a handout sending unit which sends the data of the handout extracted by said handout extracting unit to said terminal device at the reception; and
a handout printing unit which prints the handout by using the data of the handout sent from said handout sending unit.

13. The visitor support system according to claim 12,
wherein said prospective visitor information storage unit further stores information for specifying a product which a prospective visitor, who is stored, is interested in, in association with the stored information for specifying the prospective visitor,
said handout storage unit further stores product specifying information for specifying a product, which is featured at a booth specified by the stored booth specifying information, in association with the booth specifying information, and
said handout extracting unit:
comprises a product-of-interest featuring booth specifying unit which specifies a booth which features a product which the departing person is interested in, among booths specified by said unvisited booth specifying unit as not having been visited by the departing person, based on the information stored in said prospective visitor information storage unit and said handout storage unit; and
extracts data of a handout distributed at the booth specified by said product-of-interest featuring booth specifying unit from the data of handouts stored in said handout storage unit.

14. A visitor support method, comprising:
a prospective visitor information storing step of storing information for specifying a prospective visitor who has a possibility of coming to a site and staff member specifying information for specifying a staff member who is to be in charge of the prospective visitor in association with each other;
a visitor information receiving step of receiving information for specifying a visitor who is checked at a reception, from a terminal device at the reception at which visitors are checked;
a staff member acquiring step of acquiring the staff member specifying information that specifies a staff member to be in charge of the checked visitor, from the information for specifying the visitor received at said visitor information receiving step and the information stored at said prospective visitor information storing step;
a correspondence message generating step of generating a correspondence message for notifying that the visitor specified by the information for specifying the visitor received at the visitor information receiving step has arrived at the site; and
a correspondence message sending step of sending the correspondence message generated at said correspondence message generating step to an address previously assigned to the staff member specified by the staff member specifying information acquired at said staff member acquiring step.

15. A recording medium storing a program for controlling a computer to function as:
a prospective visitor information storage unit which stores information for specifying a prospective visitor who has a possibility of coming to a site and staff member specifying information for specifying a staff member who is to be in charge of the prospective visitor in association with each other;
a visitor information receiving unit which receives information for specifying a visitor who is checked at a reception, from a terminal device at the reception at which visitors are checked;
a staff member acquiring unit which acquires the staff member specifying information that specifies a staff member to be in charge of the visitor checked at the reception, based on the information for specifying the visitor received by said visitor information receiving unit, and the information stored in said prospective visitor information storage unit;
a correspondence message generating unit which generates a correspondence message for notifying that the visitor who is specified by the information for specifying the visitor received by said visitor information receiving unit has arrived at the site; and
a correspondence message sending unit which sends the correspondence message generated by said correspondence message generating unit to an address previously assigned to the staff member specified by the staff member specifying information acquired by said staff member acquiring unit.
